(19) United States
(12) Patent Application Publication
(10) Pub. No.: US 2026/0103092 A1
(43) Pub. Date: Apr. 16, 2026

(54) STRUCTURAL BATTERY FOR VEHICLE

(71) Applicants: Hyundai Motor Company, Seoul (KR); Kia Corporation, Seoul (KR)

(72) Inventor: Won Ki Song, Hwaseong-si (KR)

(21) Appl. No.: 19/237,294

(22) Filed: Jun. 13, 2025

(30) Foreign Application Priority Data
Oct. 16, 2024 (KR) 10-2024-0141016

(51) Int. Cl. B60L 50/64; H01M 4/02; H01M 4/66; H01M 50/534; H01M 50/586; H01M 50/593

(52) U.S. Cl. CPC B60L 50/64; H01M 4/663; H01M 50/534; H01M 50/586; H01M 50/593; H01M 2004/027; H01M 2004/028

(57) ABSTRACT

A structural battery for a vehicle can include negative electrode layers, electrolyte layers, positive electrode layers, where the negative electrode layers, the electrolyte layers, and the positive electrode layers are sequentially laminated from top to bottom, a glass fiber insulator disposed at an edge of each of the negative electrode layers and each of the positive electrode layers, where a negative electrode through-portion is between each of the negative electrode layers and the respective glass fiber insulator, and where a positive electrode through-portion is between each of the positive electrode layers and the respective glass fiber insulator, a negative electrode tab connected to the negative electrode layers, and a positive electrode tab connected to the positive electrode layers, where the negative electrode layers are electrically connected through the positive electrode through-portion, and wherein the positive electrode layers are electrically connected through the negative electrode through-portion.

### CROSS-REFERENCE TO RELATED APPLICATIONS

This application claims priority to and the benefit of Korean Patent Application No. 10-2024-0141016 filed with the Korean Intellectual Property Office on Oct. 16, 2024, the entire contents of which are incorporated herein by reference.

### TECHNICAL FIELD

The present disclosure relates to a structural battery for a vehicle.

### BACKGROUND

Generally, a lithium-ion battery mounted on an electric vehicle occupies a significant portion of the weight of the electric vehicle, but does not perform any load-bearing function at all.

In contrast, as illustrated in FIG. 1, a structural battery 500 is a portion that is installed in a frame or structure 800 constituting an electric vehicle 1000 and simultaneously performs own load-bearing and charging/discharging and boosting functions of a high-voltage battery 600 installed on a floor 700 of the vehicle body. In other words, the structural battery 500 may function as a battery while performing the function of an electric vehicle structure.

This battery is also called a massless energy storage device, which is because, when the weight of the battery becomes a portion of the load-bearing structure, the weight of the battery storing energy is virtually nonexistent. These composite function batteries may significantly reduce the weight of the vehicle. When the structural battery is applied to electric vehicles, the weight is reduced and a driving range may be improved.

In addition, the structural battery has a capacity of about 20% of the capacity of a lithium-ion battery, which is lower than that of the lithium-ion battery, but the weight is significantly reduced because there is no separate battery, and as a result, the energy required to drive the electric vehicle is reduced. Furthermore, the structural battery has a lower electric energy density and higher stability.

However, as shown in FIG. 2, in the structural battery 500, a negative electrode 10 and a positive electrode 20 are alternately laminated, and between the negative electrode 10 and the positive electrode 20, an electrolyte layer that implements a redox reaction and an insulating layer 40 that insulates each current collector 30 of the negative electrode 10 and the positive electrode 20 are laminated. In addition, outside a sealing region on the outside of the current collector 30, a resin is impregnated to block moisture from entering pores of the current collector 30. In addition, a sealing film 50 is attached to the outermost negative electrode 10 and positive electrode 20. That is, the structural battery electrode is formed by the laminated combination of carbon fiber electrodes 10 and 20 in which a resin is impregnated on the outside of the current collector 30 and the insulator 40, a negative electrode tab 15 and a positive electrode tab 25 are connected to each current collector 30 and protrude outward, and each of the protruding electrode tabs 15 and 25 forms an electrical connection. In the structural battery 500, as illustrated in FIG. 3, the negative electrode 10 is provided with a negative electrode slurry layer 12 on both surfaces of the current collector 30, and a negative electrode tab 15 is provided on one side of the current collector 30. The negative electrode slurry layer 12 includes a negative electrode active material, a binder, and a conductive agent.

However, carbon fiber for the load-bearing function is located outside the sealing region, and the carbon fiber current collector 30 impregnated with a resin outside the sealing region has difficulty in flowing electricity or has very high resistance, and thus, it may be difficult for the carbon fiber current collector 30 to be connected with the electrode tabs 15 and 25. In addition, there is a problem that resistance significantly increases when the electrode tabs 15 and 25 are connected to each of the laminated current collectors 30.

### SUMMARY

The present disclosure relates to a structural battery for a vehicle, and more particularly, to a structural battery for electric vehicles that may be applied as a member of a body to mechanically connect parts, while being electrochemically connected with a lithium-ion battery to boost voltage.

An embodiment of the present disclosure can provide a structural battery for an electric vehicle, which can be formed in a series-connected structure, in which an electrode through-portion can be formed in a portion of a carbon fiber current collector layer, a single electrode tab can be provided, and an electrical coupling structure can be formed between current collector layers using the electrode through-portion.

According to an example embodiment, a structural battery for an electric vehicle in which a plurality of negative electrode layers, a plurality of electrolyte layers, and a plurality of positive electrode layers can be sequentially laminated from top to bottom, wherein a glass fiber insulator can be provided at an edge of each negative electrode layer and each positive electrode layer, a negative electrode through-portion and a positive electrode through-portion can be provided between each negative electrode layer and the glass fiber insulator and between each positive electrode layer and the glass fiber insulator, an electrode tab can be connected to one of the negative electrode layers and one of the positive electrode layers, and the negative electrode layers and the positive electrode layers can be electrically connected through the positive electrode through-portion and the negative electrode through-portion, respectively.

The negative electrode layer and positive electrode layer may include a negative electrode and a positive electrode having a slurry layer applied to both surfaces of a carbon fiber current collector layer.

The negative electrode may be formed by applying a negative electrode slurry layer on both surfaces of a negative electrode carbon fiber current collector layer, and the positive electrode may be formed by applying a positive electrode slurry layer on both surfaces of a positive electrode carbon fiber current collector layer.

The carbon fiber current collector layer may be formed with a wider surface than the negative electrode slurry layer and the positive electrode slurry layer.

The negative electrode slurry layer may be formed of a negative electrode active material, a binder, and a conductive agent, and the positive electrode slurry layer may be formed of a positive electrode active material, a binder, and a conductive agent.

The electrode tab may include a negative electrode tab and a positive electrode tab electrically connected to the carbon fiber current collector layer.

The negative electrode tab may be formed in the same layer as an electrolyte layer on top of an uppermost negative electrode, and the positive electrode tab may be formed in the same layer as an electrolyte layer on top of an uppermost positive electrode.

The negative electrode tab may be electrically connected to an uppermost negative electrode carbon fiber current collector layer, and the positive electrode tab may be electrically connected to an uppermost positive electrode carbon fiber current collector layer.

Edge portions of the negative electrode layer, electrolyte layer, and positive electrode layer may be impregnated with a resin and sealed, and the negative electrode tab and positive electrode tab may be positioned to extend from the inside to the outside of the sealed region.

The negative electrode tab and positive electrode tab may be formed of aluminum (Al).

The carbon fiber current collector layers of the same polarity may be electrically connected to each other by a conductive adhesive.

The conductive adhesive may electrically connect the carbon fiber current collector layers of the same polarity to each other by passing through the negative electrode through-portion and the positive electrode through-portion.

A glass fiber structural reinforcement layer may be laminated on an outer portion of each of outermost upper and lower layers.

A pouch film may be laminated between the outermost upper and lower layers and the glass fiber structure reinforcement layer.

According to an embodiment of the present disclosure, by providing the electrode through-portion in the carbon fiber current collector and applying an electrical coupling structure between current collectors of the same polarity and between electrodes of the same polarity therethrough, one electrode tab, instead of forming an electrode tab for each layer of the current collector, may be configured, thereby reducing electrochemical resistance and increasing electrical efficiency.

According to an embodiment of the present disclosure, by using a single electrode tab structure and using glass fiber prepreg insulator as an insulator between carbon fiber current collectors, the cost may be reduced.

According to an embodiment of the present disclosure, by installing the structural battery that functions as a battery in the frame structure of the vehicle, a battery space may be saved, the layout may be improved, weight may be reduced, and fuel efficiency may be improved, and thus, the marketability of the vehicle may be improved.

### BRIEF DESCRIPTION OF THE DRAWINGS

FIG. 1 is a schematic diagram of an electric vehicle to which a structural battery for an electric vehicle according to an example embodiment of the present disclosure can be applied.

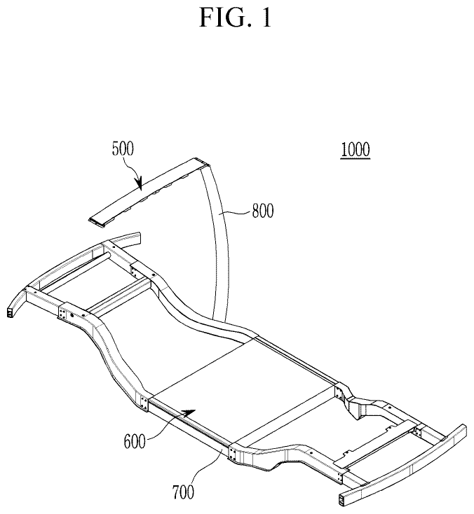

FIG. 2 is an exploded perspective view for a drawing illustrating a laminated structure of an existing structural battery for an electric vehicle.

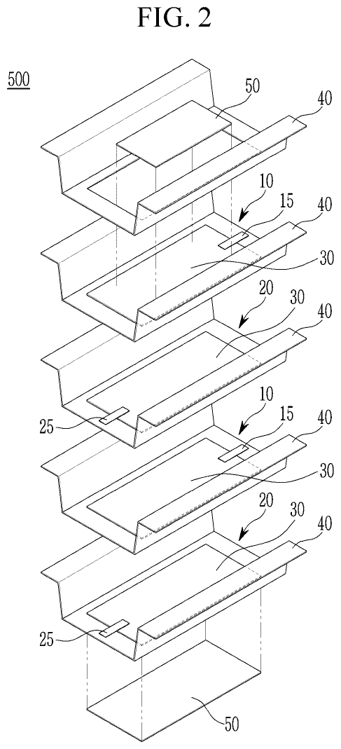

FIG. 3 is a partially exploded perspective view for a drawing illustrating a laminated structure of a negative electrode of an existing structural battery for an electric vehicle.

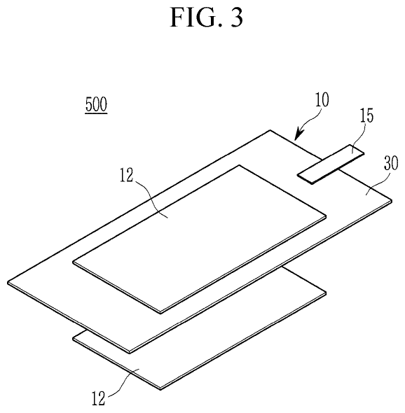

FIG. 4 is an exploded perspective view for a drawing illustrating a laminated structure of a structural battery for an electric vehicle according to an example embodiment of the present disclosure.

FIG. 5 is a perspective view for a drawing illustrating a state in which a negative electrode of a structural battery for an electric vehicle and a glass fiber insulator are coupled according to an example embodiment of the present disclosure.

FIG. 6 is a partially exploded perspective view for a drawing illustrating a state in which a negative electrode of a structural battery for an electric vehicle is coupled to a glass fiber insulator according to an example embodiment of the present disclosure.

FIG. 7 is a plan view for a drawing illustrating each of five layers constituting a structural battery for an electric vehicle according to an example embodiment of the present disclosure.

FIG. 8 is a side cross-sectional view for a drawing illustrating a structure of a structural battery for an electric vehicle according to an example embodiment of the present disclosure.

FIG. 9 is a partially exploded perspective view for a drawing illustrating a laminated structure of a negative electrode of a structural battery for an electric vehicle according to an example embodiment of the present disclosure.

FIG. 10 is a partially exploded perspective view for a drawing illustrating a laminated structure of a negative electrode of a structural battery for an electric vehicle according to an example embodiment of the present disclosure.

### DETAILED DESCRIPTION OF ILLUSTRATIVE EMBODIMENTS

Hereinafter, reference will be now made to the example embodiments of the present disclosure with reference to the attached drawings in a manner sufficiently detailed that can be readily carried out by a person skilled in the art to which the disclosure pertains. As those skilled in the art can realize, the described example embodiments may be modified in various different ways, all without departing from the spirit or scopes of the present disclosure.

In various example embodiments, components having the same configuration are representatively described in an example embodiment using the same reference numerals, and in other example embodiments, only components that are different from the an example embodiment are described.

It can be noted that the drawings are schematically illustrated but not necessarily scaled in proportion. Therefore, in the attached drawings, the relative dimensions and proportions of the components can be illustrated to be more enlarged or reduced than they actually are to clarify the present disclosure, and a certain size is just illustrative but not limited thereto. In the drawings, the same structures, elements or parts can have same reference numerals so as to denote similar features even though they can be illustrated in different figures. When it is said that any portion is positioned “on” another part, it can refer to the portion being directly on the other portion or above the other portion with at least one intermediate part.

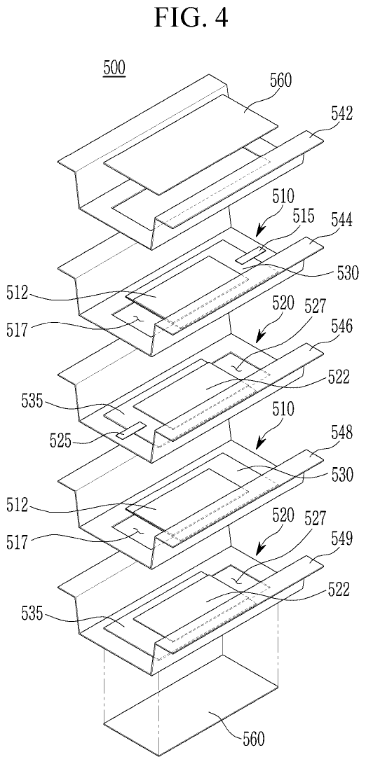

Example embodiments are described with reference to FIGS. 4 to 10. As a result, various modifications of the drawings can be anticipated. Therefore, the example embodiments are not limited to a specific form of an illustrated region, and for example, can include modifications of a manufactured form.

Hereinafter, a structural battery, and parts thereof, for an electric vehicle according to example embodiments of the present disclosure will be described with reference to FIGS. 4 to 10.

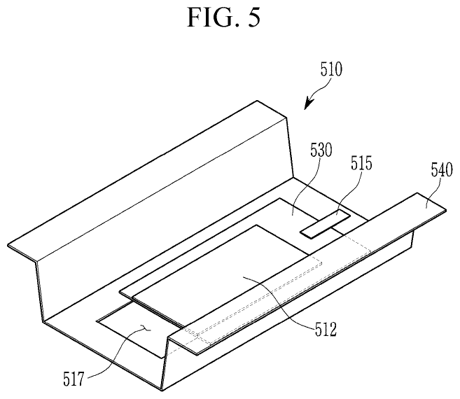

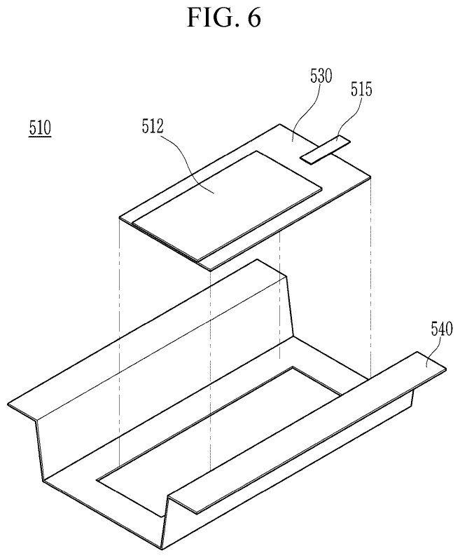

FIG. 4 is an exploded perspective view for a drawing illustrating a laminated structure of a structural battery for an electric vehicle according to an example embodiment of the present disclosure. FIG. 5 is a perspective view for a drawing illustrating a state in which a negative electrode of the structural battery for an electric vehicle and a glass fiber insulator are coupled according to an example embodiment of the present disclosure. FIG. 6 is a partially exploded perspective view for a drawing illustrating a state in which the negative electrode of the structural battery for an electric vehicle is coupled to the glass fiber insulator according to an example embodiment of the present disclosure.

Referring to FIGS. 4 to 8, in a structural battery for an electric vehicle according to an example embodiment of the present disclosure, a plurality of negative electrode layers 510, a plurality of electrolyte layers 550, and a plurality of positive electrode layers 520 can be sequentially laminated from top to bottom.

The negative electrode layer 510 can include a negative electrode in which a negative electrode slurry layer 512 is applied to both surfaces of a negative electrode carbon fiber current collector layer 530. The positive electrode layer 520 can include a positive electrode in which a positive electrode slurry layer 522 is applied to both surfaces of a positive electrode carbon fiber current collector layer 535.

The negative electrode slurry layer 512 may include a negative electrode active material, a binder, and a conductive agent, and the positive electrode slurry layer 522 may include a positive electrode active material, a binder, and a conductive agent. The negative electrode slurry layer 512 and the positive electrode slurry layer 522 may additionally include a conductive agent to supplement the conductivity of the negative electrode active material and the positive electrode active material, and the conductivity of the electrode active material may be improved by bonding each electrode active material and the conductive agent with a binder.

The negative electrode may include the negative electrode slurry layer 512, the electrolyte layer 550, and the negative electrode carbon fiber current collector layer 530, and the positive electrode may include the positive electrode slurry layer 522, the electrolyte layer 550, and the positive electrode carbon fiber current collector layer 535.

The electrolyte layer 550 may allow lithium ions to pass therethrough and block electrons, thereby implementing a redox reaction between the positive and negative electrodes, and may include a solid electrolyte.

A glass fiber insulator (prepreg) 540 may be provided at the edge of each negative electrode layer 510 and each positive electrode layer 520. The prepreg may be fiber infiltrated with resin and include a non-conductive glass fiber insulating between the carbon fiber current collector layers 530 and 535.

A negative electrode through-portion 517 and a positive electrode through-portion 527 may be provided between each negative electrode layer 510 and the glass fiber insulator 540 and between each positive electrode layer 520 and the glass fiber insulator 540, respectively.

A negative electrode tab 515 may be connected to the uppermost negative electrode layer 510, which is one of the negative electrode layers 510, and a positive electrode tab 525 may be connected to the uppermost positive electrode layer 520, which is one of the positive electrode layers 520. The negative electrode layers 510 may be electrically connected through the positive electrode through-portion 527, and the positive electrode layers 520 may be electrically connected through the negative electrode through-portion 517. The negative electrode tab 515 and the positive electrode tab 525 may be formed of aluminum (Al).

As shown in FIGS. 5 and 6, the glass fiber insulator 540 can be provided at the edge of the negative electrode layer 510, and an opening can be formed in the center of the glass fiber insulator 540. The negative electrode layer 510 can be laminated on top of the glass fiber insulator 540, and in the negative electrode layer 510, the negative electrode slurry layer 512 may be applied to both surfaces of the negative electrode carbon fiber current collector layer 530 and the negative electrode tab 515 can be provided on one side. The negative electrode slurry layer 512 may have an area smaller than an area of the negative electrode carbon fiber current collector layer 530 and may be applied so that surfaces of three portions of the negative electrode carbon fiber current collector layer 530 are exposed.

The negative electrode carbon fiber current collector layer 530 can be laminated to expose a portion of the opening of the glass fiber insulator 540. An edge portion in which the surface of the negative electrode carbon fiber current collector layer 530 is not exposed and the partially exposed opening portion of the glass fiber insulator 540 can form the rectangular-shaped negative electrode through-portion 517.

Similar to the structure of the negative electrode layer 510, the glass fiber insulator 540 having an opening may be provided at the edge of the positive electrode layer 520, the positive electrode layer 520 can be laminated on top of the glass fiber insulator 540, the positive electrode layer 520 may have the positive electrode slurry layer 522 applied to both surfaces of the positive electrode carbon fiber current collector layer 535 and the positive electrode tab 525 can be provided on one side. The positive electrode tab 525 may be formed on the opposite side of the negative electrode tab 515. The positive electrode slurry layer 522 may have an area smaller than that of the positive electrode carbon fiber current collector layer 535 and may be applied so that surfaces of three portions of the positive electrode carbon fiber current collector layer 535 are exposed.

The positive electrode carbon fiber current collector layer 535 can be laminated so as to expose a portion of the opening of the glass fiber insulator 540. An edge portion in which the surface of the positive electrode carbon fiber current collector layer 535 is not exposed and the partially exposed opening portion of the glass fiber insulator 540 can form the rectangular-shaped positive electrode through-portion 527. The positive electrode through-portion 527 may be formed on the opposite side of the negative electrode through-portion 517.

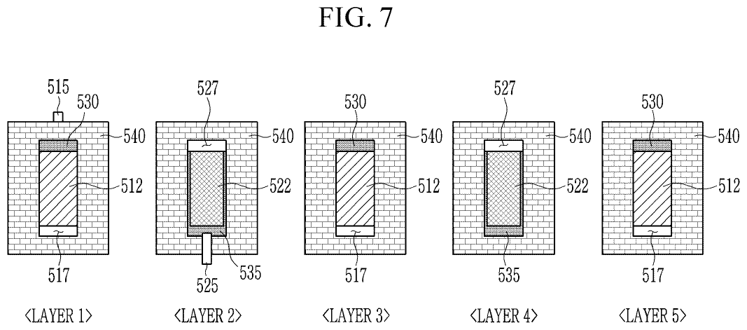

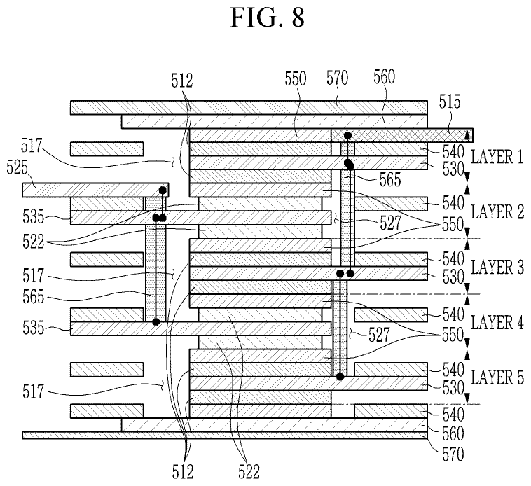

FIG. 7 is a plan view for a drawing illustrating each of five layers constituting the structural battery for an electric vehicle according to an example embodiment of the present disclosure. FIG. 8 is a side cross-sectional view for a drawing illustrating a structure of the structural battery for an electric vehicle according to an example embodiment of the present disclosure.

Referring to FIGS. 7 and 8, the structural battery for an electric vehicle according to an example embodiment of the present disclosure can have a structure in which the plurality of negative electrode layers 510, the plurality of electrolyte layers 550, and the plurality of negative electrode layers 520 are sequentially laminated from top to bottom. First, layer 1 (LAYER 1 in FIGS. 7 and 8) can constitute the negative electrode layer 510 and form the outermost upper layer. Layer 1 may be formed by applying the negative electrode slurry layer 512 to both surfaces of the negative electrode carbon fiber current collector layer 530, and the glass fiber insulator 540 can be provided at the edge. The negative electrode carbon fiber current collector layer 530 can cover a portion of the opening of the glass fiber insulator 540 to form the negative electrode through-portion 517.

The negative electrode tab 515 may be formed in the same layer as the electrolyte layer 550 above layer 1, i.e., the uppermost negative electrode, and can be electrically connected to the negative electrode carbon fiber current collector layer 530 by a conductive adhesive 565.

Layer 2 (LAYER 2 in FIGS. 7 and 8) can constitute the positive electrode layer 520 and can be disposed below layer 1. Layer 2 may be formed by applying the positive electrode slurry layer 522 to both surfaces of the positive electrode carbon fiber current collector layer 535, and the glass fiber insulator 540 can be provided on the edge. The positive electrode carbon fiber current collector layer 535 can cover a portion of the opening of the glass fiber insulator 540 to form the positive electrode through-portion 527.

The positive electrode tab 525 may be formed in the same layer as the electrolyte layer 550 above layer 2, i.e., the uppermost positive electrode and can be electrically connected to the positive electrode carbon fiber current collector layer 535 by the conductive adhesive 565.

Layer 3 (LAYER 3 in FIGS. 7 and 8) can constitute the negative electrode layer 510 having the same configuration as layer 1 and can be electrically connected to the negative electrode carbon fiber current collector layer 530 through the positive electrode through-portion 527 formed in layer 2 by the conductive adhesive 565.

Layer 4 (LAYER 4 in FIGS. 7 and 8) can constitute the positive electrode layer 520 having the same configuration as layer 2 and can be electrically connected to the positive electrode carbon fiber current collector layer 535 through the negative electrode through-portion 517 formed in layer 3 by the conductive adhesive 565.

Layer 5 (LAYER 5 in FIGS. 7 and 8) can constitute the negative electrode layer 510 having the same configuration as layers 1 and 3 and can be electrically connected to the negative electrode carbon fiber current collector layer 530 through the negative electrode through-portion 527 formed in layer 4 by the conductive adhesive 565.

As described above, the negative electrode tab 515 formed in layer 1 can be electrically connected to the negative electrode carbon electrode current collector layer 530 of layer 1 and can be electrically connected to the negative electrode carbon electrode current collector layers 530 of layer 3 and layer 5 through the positive electrode through-portion 527. The positive electrode tab 525 formed in layer 2 can be electrically connected to the positive electrode carbon electrode current collector layer 535 of layer 2 and can be electrically connected to the positive electrode carbon electrode current collector layer 535 of layer 4 through the negative electrode through-portion 517.

Therefore, it can be possible to have the single negative electrode tab 515 and the single positive electrode tab 525, while electrically connecting all layers (layer 1 to layer 5) of the structural battery. Because the electrode tabs are not connected in each current collector layer 530 and 535, the electrochemical resistance may be reduced, the electrical efficiency may be increased, and the manufacturing yield and cost may be reduced.

A glass fiber structure reinforcement layer 570 may be laminated on the outer portion of each of the outermost upper and lower layers (layer 1, layer 5).

A pouch film 560 may be laminated between the outermost upper and lower layers (layer 1, layer 5) and the glass fiber structure reinforcement layer 570.

The edge portions of the laminated negative electrode layer 510, electrolyte layer 550, and positive electrode layer 520 illustrated in FIG. 8 may be impregnated with resin and sealed, and the negative electrode tab 515 and the positive electrode tab 525 may be positioned to extend from the inner side of the sealed region toward the outer side. That is, a connection portion of the negative electrode tab 515 and the positive electrode tab 525 with the current collector layers 530 and 535 can be located inside the conductive sealing region. The resin-impregnated region can be a region in which electricity does not flow, mechanical strength is improved, and moisture, etc. does not penetrate from the outside.

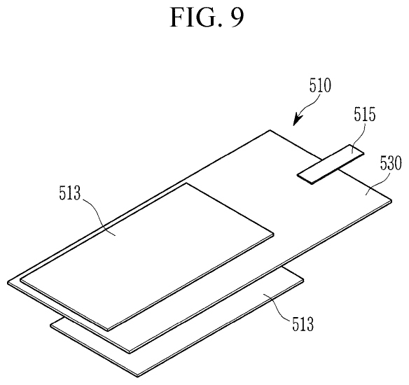

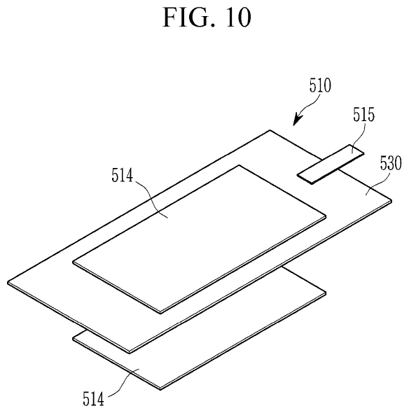

FIG. 9 is a partially exploded perspective view for a drawing illustrating a laminated structure of a negative electrode of a structural battery for an electric vehicle according to an example embodiment of the present disclosure. FIG. 10 is a partially exploded perspective view for a drawing illustrating a laminated structure of a negative electrode of a structural battery for an electric vehicle according to an example embodiment of the present disclosure.

Referring to FIG. 9, the negative electrode layer 510 may be formed by applying a negative electrode slurry layer 513 to both surfaces of the negative electrode carbon fiber current collector layer 530 and providing the negative electrode tab 515 on one side. The negative slurry layer 513 may have an area smaller than the area of the negative electrode carbon fiber current collector layer 530 and may be applied in a form that is offset to the two sides of the negative electrode carbon fiber current collector layer 530 so that surfaces of two portions of the negative electrode carbon fiber current collector layer 530 are exposed. The negative electrode carbon fiber current collector layer 530 may cover a portion of the opening of the glass fiber insulator, so that the negative electrode through-portion 517 may be formed on the opposite side of the negative electrode tab 515.

Similar to the negative electrode layer 510 (as just described regarding FIG. 9), in the positive electrode layer, the positive electrode slurry layer can have an area smaller than an area of the positive electrode carbon fiber current collector layer, and the positive electrode layer can be applied in a form that is offset to the two sides of the positive electrode carbon fiber current collector layer, so that surfaces of two portions of the positive electrode carbon fiber current collector layer are exposed.

Referring to FIG. 10, the negative electrode layer 510 may be formed by applying the negative electrode slurry layer 514 to both surfaces of the negative electrode carbon fiber current collector layer 530 and providing the negative electrode tab 515 on one side. A negative electrode slurry layer 514 may have an area smaller than the area of the negative electrode carbon fiber current collector layer 530 and may be applied to the central portion of the negative electrode carbon fiber current collector layer 530 so that surfaces of four portions of the negative electrode carbon fiber current collector layer 530 are exposed. The negative electrode carbon fiber current collector layer 530 may cover a portion of the opening of the glass fiber insulator to form the negative electrode through-portion 517 on the opposite side of the negative electrode tab 515.

Similar to the negative electrode layer 510 (as just described regarding FIG. 10), in the positive electrode layer, the positive electrode slurry layer can have an area smaller than the area of the positive electrode carbon fiber current collector layer and may be disposed so that surfaces of four portions of the positive electrode carbon fiber current collector layer are exposed.

In this manner, according to an embodiment of the disclosure, by providing the electrode through-portion in the carbon fiber current collector and applying an electrical coupling structure between current collectors of the same polarity and between electrodes of the same polarity therethrough, one electrode tab, instead of forming an electrode tab for each layer of the current collector, may be configured, thereby reducing electrochemical resistance and increasing electrical efficiency.

In an embodiment of the present disclosure, by using a single electrode tab structure and using glass fiber prepreg insulator as an insulator between carbon fiber current collectors, the cost may be reduced.

In an embodiment of the present disclosure, by installing the structural battery that functions as a battery in the frame structure of the vehicle, a battery space may be saved, the layout may be improved, weight may be reduced, and fuel efficiency may be improved, and thus, the marketability of the vehicle may be improved.

While the present disclosure has been described in connection with what is presently considered to be practical example embodiments, it can be understood that the present disclosure is not necessarily limited to the disclosed example embodiments. On the contrary, it is intended to cover various modifications and equivalent arrangements included within the spirit and scopes of the appended claims.

What is claimed is:

1. A structural battery for a vehicle, comprising:
a plurality of negative electrode layers;
a plurality of electrolyte layers;
a plurality of positive electrode layers, wherein the negative electrode layers, the electrolyte layers, and the positive electrode layers are sequentially laminated from top to bottom;
a glass fiber insulator disposed at an edge of each of the negative electrode layers and each of the positive electrode layers, wherein a negative electrode through-portion is between each of the negative electrode layers and the respective glass fiber insulator, and wherein a positive electrode through-portion is between each of the positive electrode layers and the respective glass fiber insulator;
a negative electrode tab connected to the negative electrode layers; and
a positive electrode tab connected to the positive electrode layers, wherein
the negative electrode layers are electrically connected through the positive electrode through-portion, wherein the positive electrode layers are electrically connected through the negative electrode through-portion.

2. The structural battery of claim 1, wherein each of the negative electrode layers and each of the positive electrode layers comprise a negative electrode and a positive electrode, respectively, each having a slurry layer applied to both surfaces of a carbon fiber current collector layer.

3. The structural battery of claim 2, wherein the negative electrode has a negative electrode slurry layer on both surfaces of a negative electrode carbon fiber current collector layer, and
wherein the positive electrode has a positive electrode slurry layer on both surfaces of a positive electrode carbon fiber current collector layer.

4. The structural battery of claim 3, wherein the negative electrode carbon fiber current collector layer has a negative-electrode surface wider than the negative electrode slurry layer, and wherein the positive electrode carbon fiber current collector layer has a positive-electrode surface wider than the positive electrode slurry layer.

5. The structural battery of claim 3, wherein the negative electrode slurry layer comprises a negative-electrode active material, a negative-electrode binder, and a negative-electrode conductive agent, and
wherein the positive electrode slurry layer comprises a positive-electrode active material, a positive-electrode binder, and a positive-electrode conductive agent.

6. The structural battery of claim 3, wherein the negative electrode tab is electrically connected to the negative electrode carbon fiber current collector layer, and
wherein the positive electrode tab is electrically connected to the positive electrode carbon fiber current collector layer.

7. The structural battery of claim 6, wherein the negative electrode tab is disposed at a same uppermost-negative layer as an uppermost-negative-positioned electrolyte layer of the electrolyte layers on top of an uppermost negative electrode, and
wherein the positive electrode tab is disposed at a same uppermost-positive layer as an uppermost-positive-positioned electrolyte layer of the electrolyte layers on top of an uppermost positive electrode.

8. The structural battery of claim 7, wherein the negative electrode tab is electrically connected to an uppermost negative electrode carbon fiber current collector layer, and wherein the positive electrode tab is electrically connected to an uppermost positive electrode carbon fiber current collector layer.

9. The structural battery of claim 8, wherein edge portions of the negative electrode layers, the electrolyte layers, and the positive electrode layers are impregnated with resin and sealed, and
wherein the negative electrode tab and the positive electrode tab extend from inside of to outside of a sealed region of the resin.

10. The structural battery of claim 6, wherein the negative electrode tab and the positive electrode tab comprise aluminum.

11. The structural battery of claim 8, wherein the negative electrode carbon fiber current collector layers are electrically connected to each other by a negative conductive adhesive, and wherein the positive electrode carbon fiber current collector layers are electrically connected to each other by a positive conductive adhesive.

12. The structural battery of claim 11, wherein the negative conductive adhesive passes through the positive electrode through-portion, and wherein the positive conductive adhesive passes through the negative electrode through-portion.

13. The structural battery of claim 1, further comprising:
an uppermost glass fiber structural reinforcement layer laminated on an uppermost outer portion of an uppermost layer of the structural battery; and
a lowermost glass fiber structural reinforcement layer laminated on a lowermost outer portion of a lowermost layer of the structural battery.

14. The structural battery of claim 13, further comprising:
an uppermost pouch film laminated between the uppermost glass fiber structural reinforcement layer and the uppermost layer of the structural battery; and
a lowermost pouch film laminated between the lowermost glass fiber structural reinforcement layer and the lowermost layer of the structural battery.

15. A structural battery for a vehicle, comprising:
a negative-electrode carbon-fiber current collector layer having negative-electrode slurry layers on each side thereof; and
a negative-electrode glass-fiber insulator fixed to the negative-electrode carbon-fiber current collector layer, wherein the negative-electrode glass-fiber insulator has a negative-electrode-glass-fiber-insulator inner opening partially covered by the negative-electrode carbon-fiber current collector layer such that a negative electrode through-portion is between a negative-electrode-carbon-fiber-current-collector-layer outer edge of the negative-electrode carbon-fiber current collector layer and a negative-electrode-glass-fiber-insulator inner edge of the negative-electrode-glass-fiber-insulator inner opening.

16. The structural battery of claim 15, further comprising:
a positive-electrode carbon-fiber current collector layer having positive-electrode slurry layers on each side thereof;
a positive-electrode glass-fiber insulator fixed to the positive-electrode carbon-fiber current collector layer, wherein the positive-electrode glass-fiber insulator has a positive-electrode-glass-fiber-insulator inner opening partially covered by the positive-electrode carbon-fiber current collector layer such that a positive electrode through-portion is between a positive-electrode-carbon-fiber-current-collector-layer outer edge of the positive-electrode carbon-fiber current collector layer and a positive-electrode-glass-fiber-insulator inner edge of the positive-electrode-glass-fiber-insulator inner opening; and
a first electrolyte layer between the positive-electrode carbon-fiber current collector layer and the negative-electrode carbon-fiber current collector layer.

17. A structural battery for a vehicle, comprising:
a first negative-electrode layer comprising:
a first negative-electrode carbon-fiber current collector layer having first negative-electrode slurry layers on each side thereof, and
a first negative-electrode glass-fiber insulator fixed to the first negative-electrode carbon-fiber current collector layer, wherein the first negative-electrode glass-fiber insulator has a first negative-electrode-glass-fiber-insulator inner opening partially covered by the first negative-electrode carbon-fiber current collector layer such that a first negative electrode through-portion is between a first negative-electrode-carbon-fiber-current-collector-layer outer edge of the first negative-electrode carbon-fiber current collector layer and a first negative-electrode-glass-fiber-insulator inner edge of the first negative-electrode-glass-fiber-insulator inner opening;
a first positive-electrode layer comprising:
a first positive-electrode carbon-fiber current collector layer having first positive-electrode slurry layers on each side thereof, and
a first positive-electrode glass-fiber insulator fixed to the first positive-electrode carbon-fiber current collector layer, wherein the first positive-electrode glass-fiber insulator has a first positive-electrode-glass-fiber-insulator inner opening partially covered by the first positive-electrode carbon-fiber current collector layer such that a first positive electrode through-portion is between a positive-electrode-carbon-fiber-current-collector-layer outer edge of the first positive-electrode carbon-fiber current collector layer and a first positive-electrode-glass-fiber-insulator inner edge of the first positive-electrode-glass-fiber-insulator inner opening; and
a first electrolyte layer between the first negative-electrode layer and the first positive-electrode layer, wherein the first negative electrode through-portion is on a first side of the structural battery, wherein the first positive electrode through-portion is on a second side of the structural battery, and wherein the first side is opposite the second side.

18. The structural battery of claim 17, further comprising:
a negative electrode tab electrically connected to the first negative-electrode layer on the second side adjacent the first positive electrode through-portion; and
a positive electrode tab electrically connected to the first positive-electrode layer on the first side adjacent the first negative electrode through-portion.

19. The structural battery of claim 18, further comprising:
a second negative-electrode layer comprising:
a second negative-electrode carbon-fiber current collector layer having second negative-electrode slurry layers on each side thereof, and
a second negative-electrode glass-fiber insulator fixed to the second negative-electrode carbon-fiber current collector layer, wherein the second negative-electrode glass-fiber insulator has a second negative-electrode-glass-fiber-insulator inner opening partially covered by the second negative-electrode carbon-fiber current collector layer such that a second negative electrode through-portion is between a second negative-electrode-carbon-fiber-current-collector-layer outer edge of the second negative-electrode carbon-fiber current collector layer and a second negative-electrode-glass-fiber-insulator inner edge of the second negative-electrode-glass-fiber-insulator inner opening,
wherein the first positive-electrode layer is between the first negative-electrode layer and the second negative-electrode layer, and
wherein the second negative-electrode carbon-fiber current collector layer is electrically connected to the first negative-electrode carbon-fiber current collector layer and the negative electrode tab via a negative-electrode adhesive passing through the first positive electrode through-portion;
a second positive-electrode layer comprising:
a second positive-electrode carbon-fiber current collector layer having second positive-electrode slurry layers on each side thereof, and
a second positive-electrode glass-fiber insulator fixed to the second positive-electrode carbon-fiber current collector layer, wherein the second positive-electrode glass-fiber insulator has a second positive-electrode-glass-fiber-insulator inner opening partially covered by the second positive-electrode carbon-fiber current collector layer such that a second positive electrode through-portion is between a positive-electrode-carbon-fiber-current-collector-layer outer edge of the second positive-electrode carbon-fiber current collector layer and a second positive-electrode-glass-fiber-insulator inner edge of the second positive-electrode-glass-fiber-insulator inner opening,
wherein the second negative-electrode layer is between the first positive-electrode layer and the second positive-electrode layer, and
wherein the second positive-electrode carbon-fiber current collector layer is electrically connected to the first positive-electrode carbon-fiber current collector layer and the positive electrode tab via a positive-electrode adhesive passing through the second negative electrode through-portion.

20. The structural battery of claim 19, further comprising:
a third negative-electrode layer comprising:
a third negative-electrode carbon-fiber current collector layer having third negative-electrode slurry layers on each side thereof, and
a third negative-electrode glass-fiber insulator fixed to the third negative-electrode carbon-fiber current collector layer, wherein the third negative-electrode glass-fiber insulator has a third negative-electrode-glass-fiber-insulator inner opening partially covered by the third negative-electrode carbon-fiber current collector layer such that a third negative electrode through-portion is between a third negative-electrode-carbon-fiber-current-collector-layer outer edge of the third negative-electrode carbon-fiber current collector layer and a third negative-electrode-glass-fiber-insulator inner edge of the third negative-electrode-glass-fiber-insulator inner opening,
wherein the second positive-electrode layer is between the second negative-electrode layer and the third negative-electrode layer, and
wherein the third negative-electrode carbon-fiber current collector layer is electrically connected to the negative electrode tab via the negative-electrode adhesive passing through the second positive electrode through-portion.
